(19) United States
(12) Patent Application Publication
(10) Pub. No.: US 2020/0064912 A1
(43) Pub. Date: Feb. 27, 2020

(54) EYE GAZE TRACKING OF A VEHICLE PASSENGER

(71) Applicant: Ford Global Technologies, LLC, Dearborn, MI (US)

(72) Inventors: Anthony Melatti, Dearborn, MI (US); Hamid M. Golgiri, Livonia, MI (US); Danielle Rosenblatt, Dearborn, MI (US); Jack Van hoecke, Dearborn, MI (US)

(73) Assignee: Ford Global Technologies, LLC, Dearborn, MI (US)

(21) Appl. No.: 16/109,415

(22) Filed: Aug. 22, 2018

(51) Int. Cl. G06F 3/01; G06K 9/00; G06Q 30/02

(52) U.S. Cl. CPC G06F 3/013; G06K 9/00791; G06T 7/70; G06K 2209/27; G06Q 30/0243

(57) ABSTRACT

Systems, methods, and devices for determining an object identification hit for an object within a user's approximate field of vision during a vehicle trip are provided. A method of the disclosure includes determining eye tracking data associated with a user of a vehicle from a vehicle sensor and determining a field of vision of the user based on the eye tracking data. The method includes determining object data associated with an object within the field of vision and identifying the object within the field of vision based on the object data to produce an object identification hit. The method includes storing the object identification hit in memory.

### TECHNICAL FIELD

The disclosure relates generally to systems, methods, and devices for tracking and recognizing eye gaze of a vehicle passenger, and particularly to determining an object hit based on the eye gaze of the vehicle passenger.

### BACKGROUND

Ride sharing platforms and applications permit users to request or reserve a shared vehicle for travel. Due to the increasing selection of ride sharing options, users may find it possible to meet their transportation needs without purchasing or owning their own vehicle. Reserving a vehicle for transportation is becoming a popular method of transportation because passengers may, among other things, obtain convenient and private transportation and share transportation costs. Ride sharing platforms and applications may allow a user to reserve a vehicle that may be driven by an operator, reserve an autonomous vehicle that may drive itself, or reserve a vehicle that the user will personally drive.

### BRIEF DESCRIPTION OF THE DRAWINGS

Non-limiting and non-exhaustive implementations of the present disclosure are described with reference to the following figures, wherein like reference numerals refer to like objects throughout the various views unless otherwise specified. Advantages of the present disclosure will become better understood with regard to the following description and accompanying drawings where:

FIG. 1 is a schematic diagram illustrating a system for identifying an object, according to one implementation;

FIG. 2 illustrates an eye tracking sensor detecting a field of vision of a user, according to one implementation;

FIG. 3 illustrates an example field of vision of a user as determined by an eye tracking sensor, according to one implementation;

FIG. 4 illustrates a schematic block diagram of an object identification component, according to one implementation;

FIG. 5 illustrates a schematic block diagram of example components of a saliency component, according to one implementation;

FIG. 6 is a schematic flow chart diagram illustrating a method for identifying an object within a field of vision of a user, according to one implementation;

FIG. 7 is a schematic flow chart diagram illustrating a method for identifying an object within a field of vision of a user, according to one implementation;

FIG. 8 is a schematic block diagram illustrating an implementation of a vehicle control system that includes an automated driving/assistance system, according to one implementation;

FIG. 9 is a schematic block diagram illustrating an example computing system, according to one implementation; and

FIG. 10 is a schematic block diagram illustrating an example process flow of a method for determining an object identification hit of a user of a vehicle, according to one implementation.

### DETAILED DESCRIPTION

Applicant recognizes that in a competitive ride sharing market, there is a need to offer variable pricing or reduced pricing to ride sharing customers. In such an environment, a customer may elect to provide, for example, eye tracking data through the duration of the ride in exchange for a reduced fare on the ride share. The ride sharing provider may maintain a profit by selling data received to, for example, advertisers, researchers, and other marketers. In such an embodiment, the ride sharing provider may sell data indicating, for example, what billboards or other advertisements the user viewed during the ride, what route the user traversed, and the user's attention span for various advertisements.

Applicant presents methods, systems, and devices for identifying objects within a user's field of vision during a ride in a vehicle. Such methods, systems, and devices may provide increased revenue for ride sharing providers by utilizing eye tracking technology and vehicle localization technology to determine the objects of focus for one or more users in a vehicle. Such objects of focus may register as object identification hits or “hits” that can be accumulated by the vehicle controller, stored in a cloud-based server, and provided to interested parties at a cost. Such hits can apply to various objects, including advertising signs, buildings, roadways, in-vehicle advertisements, mobile phone advertisements, and so forth. In various embodiments, such methods, systems, and devices may be configured to collect eye tracking data when a ride sharing user provides positive affirmation that he wishes to participate in the data collection.

Systems, methods, and devices for identifying an object within a vehicle user's field of vision during a vehicle ride are provided. In ride sharing environments or other driving environments where users view one or more advertisements during a trip, it can be beneficial to utilize eye tracking technology to determine what a user has viewed or focused on throughout the trip. Such data can be beneficial to advertisers, marketers, and other parties and may be sold to such interested parties. In an embodiment, a user may elect to participate in providing eye tracking data that may determine objects within the user's field of vision throughout the ride share trip and may determine object identification hits indicating objects the user focused on during the trip. The user may elect to provide such data in exchange for a reduced fare on the ride share trip, and the ride sharing provider may sell such data to advertisers, marketers, and so forth.

Eye tracking sensors may provide measurements and data concerning a gaze of a user or an approximate field of vision for a user. Such measurements and data may be utilized to determine an object of focus within the approximate field of vision of the user. In various fields including advertising, marketing, and economic research, eye tracking data and data related to a user's focus can be used to determine the effectiveness of an advertisement or to develop a user profile indicating the user's preferences for certain products or advertisements. Such data can be collected when a user is viewing surrounding objects and advertisements during a vehicle trip, and such data can be sold to interested parties for conducting market research.

In the present disclosure, Applicant proposes and presents systems, methods, and devices for determining an object identification hit for an object that is approximately within a user's field of vision during a vehicle trip. Such systems, methods, and devices may include an eye tracking sensor and a vehicle controller in communication with the eye tracking sensor. Such systems, methods, and devices may be integrated with a neural network such as a convolutional neural network (CNN) based on such CNN used for object detection and trained with a labeled training dataset.

Before the methods, systems, and devices for determining an object identification hit are disclosed and described, it is to be understood that this disclosure is not limited to the configurations, process steps, and materials disclosed herein as such configurations, process steps, and materials may vary somewhat. It is also to be understood that the terminology employed herein is used for describing various possible implementations and is not intended to be limiting.

In describing and claiming the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional elements or method steps.

According to one embodiment of the disclosure, a method for determining an object identification hit for an approximate field of vision of a user during a vehicle trip is disclosed. The method includes determining eye tracking data associated with a user of a vehicle from a vehicle sensor such as an eye tracking sensor. The method includes determining a field of vision, or an approximate field of vision, of the user based on the eye tracking data. The method includes determining object data associated with an object within the field of vision. The method includes identifying the object within the field of vision based on the object data. The method includes determining an object identification hit based on the eye tracking data. The method includes storing the object identification hit in memory.

According to one embodiment, a system for determining an object identification hit for an object approximately within a user's field of vision during a vehicle trip is disclosed. The system includes a vehicle sensor. The system includes a vehicle controller in electronic communication with the vehicle sensor, wherein the vehicle controller comprises computer-readable storage media storing instructions that, when executed by one or more processors, cause the one or more processors to: determine eye tracking data associated with a user of a vehicle from the vehicle sensor; determine a field of vision of the user of the vehicle based on the eye tracking data; determine object data associated with an object within the field of vision; identify the object within the field of vision based on the object data; determine an object identification hit based on the eye tracking data; and store the object identification hit in memory.

According to one embodiment, a neural network comprises a CNN based on those used for object detection that may be trained with a labeled training dataset of object images that will function as a classifier. The convolutional layers apply a convolution operation to an input, such as an image of an object, and pass the result to the next layer. The neural network may be trained to identify and recognize various objects with a threshold level of accuracy. The neural network may be further trained to determine a confidence value for each object identification that is performed by the neural network.

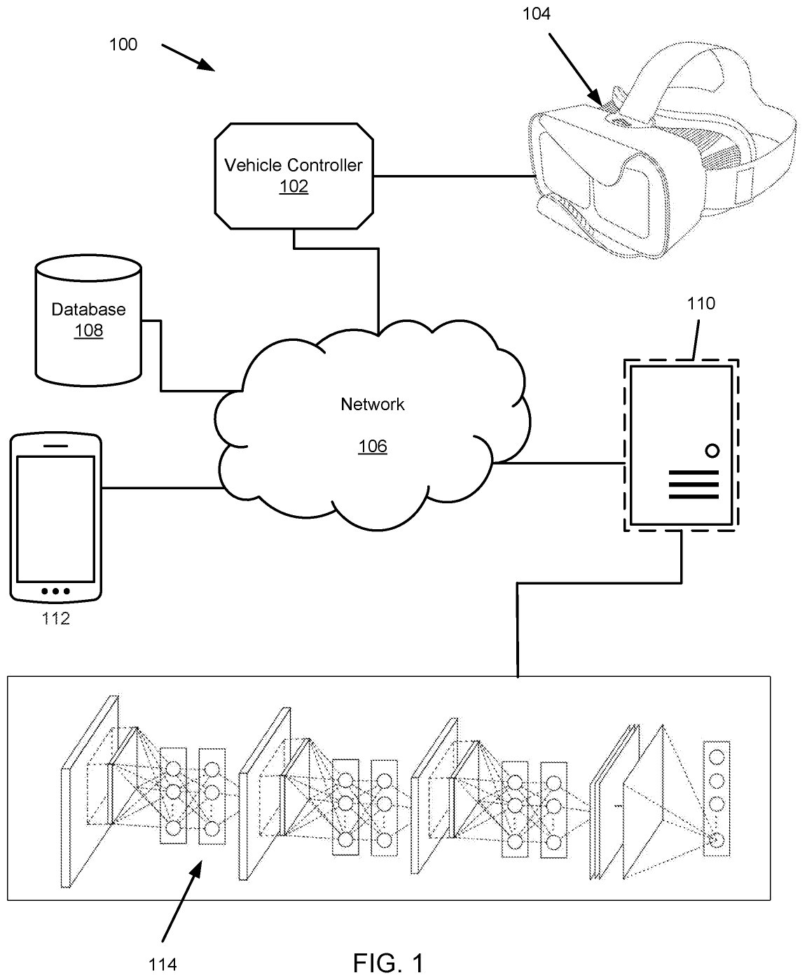

Referring now to the figures, FIG. 1 illustrates an example system 100 that may be used for identifying a gaze of a user and/or identifying an object identification hit corresponding to an object within the user's field of vision. The system 100 may include a vehicle controller 102 that may be physically located on or within a vehicle and in communication with a network 106 such as a cloud computing network. The system 100 may include an eye tracking sensor 104 in communication with the vehicle controller 102. The system may include a database 108 in communication with the network 106 that may further be in direct communication with the vehicle controller 102 or stored locally in the vehicle. The system 100 may include a server 110 in communication with the network 106 and a neural network 114 such as a convolutional neural network. The system 100 may include a computing device 112 such as a mobile phone (as illustrated) or any other suitable computing device 112 that is in communication with the network 106.

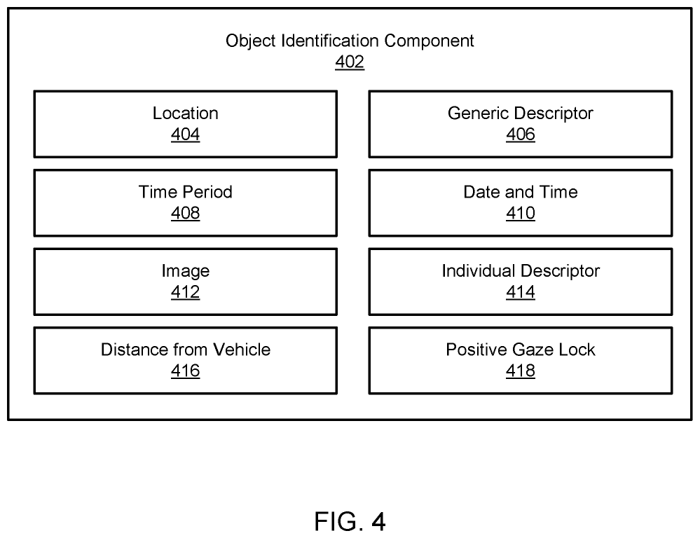

The vehicle controller 102 may include a processor or computing device that may be physically located in the vehicle. In an embodiment the vehicle controller 102 may be configured to receive sensor data from a plurality of vehicle sensors and may be configured to operate an automated driving system or driving assistance system. The vehicle controller 102 may be in communication with the network 106 and may send and receive data from the network, including database 108 data that may further be in communication with the network 106. In an embodiment a user may interact directly with the vehicle controller 102 and, for example, provide an indication to the vehicle controller 102 that the user wishes to engage with the system 100 and provide eye tracking data to the eye tracking sensor 104. In an embodiment, the vehicle controller 102 receives object data from an object identification component (see 402 at FIG. 4) and provides the object data to the network 106 to be stored.

The eye tracking sensor 104 may include any suitable eye tracking sensor 104 known in the art, including for example, an optical tracking sensor, a screen-based eye tracking sensor or gaze tracking sensor, a wearable eye tracker such as glasses or goggles, an eye tracking headset, and so forth. The eye tracking sensor 104 may include one or more cameras capable of capturing images or video streams. It should be appreciated the eye tracking sensor 104 may include one or more additional sensors that may aid in identifying a user's eye gaze. Such sensors include for example, LIDAR sensors, radar sensors, accelerometers, a global position system (GPS) sensor, a heat map sensor, and so forth. In an embodiment, the eye tracking sensor 104 may be mounted in the vehicle, for example on the front console, on the front windshield, on the back of a headrest to track a gaze of a user seated in a rear seat, and so forth. In an embodiment the eye tracking sensor 104 may be moved to different locations in the vehicle to suit the needs of a user. In an embodiment, the eye tracking sensor 104 may include glasses or goggles suitable for eye tracking or gaze tracking, and a user may wear the glasses or goggles when engaging with the system 100. In an embodiment, the eye tracking sensor 104 may be configured to activate after a user has provided positive confirmation that the user wishes to permit the eye tracking sensor 104 to collect eye tracking or gaze tracking data.

The database 108 may be in communication with the vehicle controller 102 via the network 106 or may be local to the vehicle and in direct communication with the vehicle controller 102. The database 108 may store any suitable data, including map data, location data, past eye tracking data, past object data, past user history data, and so forth. In an embodiment, the database 108 stores information about objects exterior to the vehicle on various routes of the vehicle, and that data assists in determining an identity of an object that a user is viewing based on a current location of the vehicle and current eye tracking data.

The computing device 112 may be any suitable computing device, including a mobile phone, a desktop computer, a laptop computer, a processor, and so forth. The computing device 112 provides user (or client) access to the network 106. In an embodiment, a user engages with the network 106 via a computing device 112 and creates a client account. The client account may permit the user to, for example, provide preference specifications that may be uploaded and utilized by any vehicle controller 102 in communication with the network 106. The client account may further enable the user to participate in ride sharing opportunities with any vehicle in the network 106. In an embodiment, the user provides positive confirmation of a desire to provide eye tracking data on a trip via the computing device 112 in communication with the network 106. In an embodiment, the user may receive a discounted fare on a ride sharing trip in exchange for providing eye tracking data throughout a duration of the trip.

The server 110 may be in communication with the network 106 and may receive information from the eye tracking sensor 104 via the vehicle controller 102 and the network 106. The server 110 may be further in communication with a neural network 114 such as a convolutional neural network and may send and receive information from the neural network 114. In an embodiment, the server 110 receives data from the vehicle controller 102 via the network 106 such as eye tracking data from the eye tracking sensor 104 and object data from one or more vehicle sensors. The server 110 may provide object data, such as an image of an object within the user's field of vision, to the neural network 114 for processing. The neural network 114 may determine an identity of an object captured with the object data and may return the identification to the server 110. In an embodiment, the server 110 receives and/or extracts an image comprising one or more objects within the user's field of vision (as determined by data provided by the eye tracking sensor 104). The server 110 applies a color and magnitude of gradients threshold to the image to effectively remove a background of the image, leaving an outline of possible objects of interest within the image (e.g., the one or more objects). The server 110 determines a contour of the object to determine a mask that is representative of where the object is located in the original image. The server 110 utilizes the contour to determine a bounding perimeter that encapsulates the entire contour of the object. The bounding perimeter may be applied to the original image and a sub-image may be created by the bounding perimeter on the original image. The server 110 resizes the sub-image to fit into a machine learning model utilized by the neural network 114. The server 110 provides the sub-image to the neural network 114.

The neural network 114 may be in communication with the server 110 and may be in direct communication with the network 106. In an embodiment, the neural network 114 may be configured to receive an image of an object within the user's field of vision and determine an identification of the object. In an embodiment, the neural network 114 receives the sub-image from the server 110 in one channel such that the image is grayscale. In an embodiment, the neural network 114 receives images in one channel, rather than three channels (e.g., like a color image) to reduce the number of nodes in the neural network 114. Decreasing the number of nodes in the neural network 114 significantly increases processing time without providing a significant decrease in accuracy. The neural network 114 determines a prediction label comprising a prediction of an identity of the object in the sub-image. The prediction label indicates, for example: a generic descriptor of the object, e.g. billboard, building, pedestrian, vehicle advertisement, etc.; an individual descriptor of the object, e.g. a billboard by a particular company, a particular trademark or trade name, a particular advertising scheme, etc., and so forth. The neural network 114 determines a confidence value comprising a statistical likelihood that the prediction label is correct. In an embodiment, the confidence value represents a percentage likelihood that the prediction label is correct. The determination of the confidence value may be based on one or more parameters, including for example, the quality of the image received by the neural network 114, the number of similar objects that the object in question may be mismatched with, a past performance by the neural network 114 in correctly identifying that prediction label, and so forth. The neural network 114 provides the prediction label and the confidence value to the server 110.

In an embodiment, the neural network 114 may be a convolutional neural network (CNN) as known in the art. The CNN comprises convolutional layers as the core building block of the neural network 114. A convolutional layer's parameters include a set of learnable filters or kernels, which have a small receptive field, but extend through the full depth of the input volume. During the forward pass, each filter may be convolved across the width and height of the input volume, computing the dot product between the entries of the filter and the input and producing a two-dimensional activation map of the filter. As a result, the neural network 114 learns filters that activate when it detects a specific type of feature, such as a specific feature on an object, at some spatial position in the input. In the neural network 114, stacking the activation maps for all filters along the depth dimension forms the full output volume of the convolution layer. Every entry in the output volume can thus also be interpreted as an output of a neuron that looks at a small region in the input and shares parameters with neurons in the same activation map. The neural network 114 as a CNN can successfully accomplish image recognition, including identifying an object from an image captured by an eye tracking sensor 104, at a very low error rate.

Further by way of example with respect to the neural network 114, a single camera image (or other single set of sensor data) may be provided to common layers of the neural network 114, which act as a base portion of the neural network 114. The common layers perform feature extraction on the image and provide one or more output values that reflect the feature extraction. Because the common layers were trained for each of the tasks, the single feature extraction extracts features needed by all of the tasks. The feature extraction values are output to the subtask portions including for example, first task layers, second task layers, and third task layers. Each of the first task layers, the second task layers, and the third task layers process the feature extraction values from the common layers to determine outputs for their respective tasks.

It is understood by one of skill in the art that a single neural network 114 may be composed of a plurality of nodes and edges connecting the nodes. Weights or values for the edges or nodes are used to compute an output for an edge connecting to a subsequent node. A single neural network 114 may thus be composed of a plurality of neural networks to perform one or more tasks. The neural network 114 of FIG. 1 may include some common layers as a base portion or common portion of the neural network 114. The common layers may be understood as forming a sub network of the neural network 114. The computations and processing done in the common layers are then used by first task layers, second task layers, third task layers, and so forth. Thus, the neural network 114 may include a branching topology where the results of the common layers are then used independently by each of a plurality of subnetworks in branches of the neural network 114. Because the common layers were trained sequentially on a plurality of tasks to avoid forgetting previously trained tasks, the common layers may perform a task that serves each of the neural network branches well. Furthermore, the common layers result in reduced computing because the task of the common layers may be performed once for all tasks represented by the branches, instead of once for each task. One example of the task to be performed by the common layers is feature extraction. However, any tasks that may have a shared initial processing task may share common layers.

In an embodiment of the disclosure, a means for mitigating false participation in the collection of eye tracking data may be provided. The process of mitigating false participation prevents users from appearing to be participating in the collection of eye tracking data when they are not, and appearing to have more users in the vehicle than there are in reality. In an embodiment, the system 100 learns biometrics for a user, may store the biometric data for example on a blockchain database, and may check the biometric data each time the user participates in the collection of eye tracking data. Such biometric data may include, for example, weight (using an occupant classification sensor), facial structure, eye color, and so forth. In an embodiment, the system 100 checks for periodic movement by the user and for a level of randomness in the eye's focus. In such an embodiment, the system 100 may detect if a user has installed a dummy to falsely participate by providing false eye tracking data. In an embodiment, the system 100 will enable a user to participate in the collection of eye tracking data when the user's smartphone may be connected to the vehicle controller 102.

In an embodiment of the disclosure, a user may be encouraged to participate and permit an eye tracking sensor 104 to track the user's eye movements during a vehicle trip. In such an embodiment, the user may receive an advertisement indicating that the user will receive a reduced fare for the ride, or may be compensated after the ride, if the user permits the eye tracking sensor 104 to track the user's eye movements. The user may receive such an advertisement on, for example, a computing device 112 such as the user's mobile phone. The advertisement may encourage the user to view advertisements on his computing device 112 such as his mobile phone or it may encourage the user to look at his surroundings. In such an embodiment, a user receives a prompt to provide eye tracking data when the user enters the vehicle.

In an embodiment of the disclosure, the vehicle controller 102 receives eye tracking data from the eye tracking sensor 104. The vehicle controller 102 detects and calculates an approximate field of vision of the user based on the eye tracking data, including calculating a gaze of the user based on measurements received from the eye tracking sensor 104. In an embodiment the vehicle controller 102 calculates the approximate field of vision based on the gaze of the user and an average peripheral vision capability of an average user. In an embodiment, the vehicle controller 102 further receives data pertaining to the field of vision from a vehicle sensor, such as a camera external to the vehicle, a camera in the interior cabin of the vehicle, a LIDAR sensor, a radar sensor, and so forth. In such an embodiment the vehicle controller 102 may be configured to merge the calculated field of vision with the data received from the vehicle sensor such that the vehicle controller 102 detects, for example, an image equal to the field of vision that does not include additional data outside the field of vision.

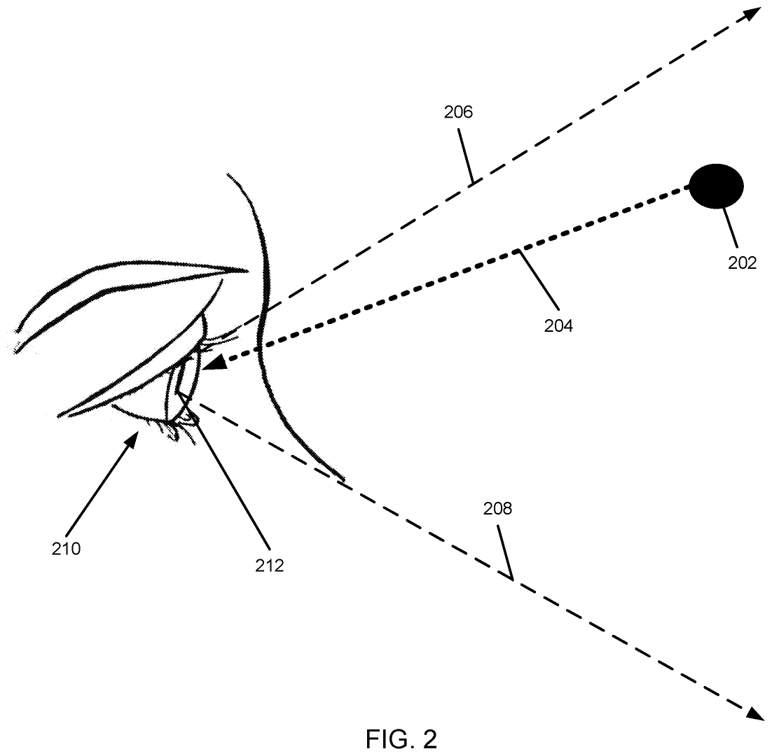

FIG. 2 illustrates an eye tracking sensor 202 viewing a pupil 212 of a user's eye 210. The eye tracking sensor 202 gazes 204 at the pupil 212 and calculates and determines a field of vision of the user's eyes 210. In an embodiment, data received from the eye tracking sensor 202 provides an upper bound 206 of the field of vision and a lower bound 208 of the field of vision, along with bounds on the sides (not illustrated). In an embodiment, data from the eye tracking sensor 202 provides a complete view of the field of vision of the user's eyes 210.

The eye tracking sensor 202 measures either the point of gaze (where a user is looking) or the motion of a user's eye relative to the user's head. The eye tracking sensor 202 measures eye positions and eye movement. Various embodiments of eye tracking sensors 202 may be used, including those that use video images from which the eye position is extracted. In an embodiment, an eye-attached eye tracking sensor 202 may be used wherein the eye tracking sensor 202 may be attached to the user's eye and may include an embedded mirror or magnetic field sensor, and the movement of the user's eye may be measured with the assumption that the eye tracking sensor 202 does not slip significantly as the user's eye rotates. In an embodiment, an optical tracking eye tracking sensor 202 may be used wherein light (typically infrared) is reflected from the eye and sensed by a video camera or other optical sensor. In such an embodiment, the measurements may be analyzed to extract eye rotation from changes in reflections. Such video-based trackers may use corneal reflection and the center of the pupil as features to track over time. Further, a similar embodiment may track features inside the eye such as the retinal blood vessels.

The eye tracking sensor 202 may be configured to measure the rotation of the eye with respect to some frame of reference and may be tied to a particular measuring system. Thus, in an embodiment where the eye tracking sensor 202 is head-mounted, as with a system mounted to a helmet or goggles, the eye-in-head angles are measured. To deduce the line of sight in world coordinates, the head may be kept in a constant position or its movements may be tracked as well. In these cases, head direction may be added to eye-in-head direction to determine gaze direction. In an alternative embodiment where the eye tracking sensor 202 is table-mounted, then gaze angles are measured directly in world coordinates. A head-centered reference frame may be positioned identical to a world-centered reference frame for the eye tracking sensor 202. In such an embodiment the eye-in-head position directly determines the gaze direction. In further embodiment, the eye tracking sensor 202 can detect eye movements under natural conditions where head movements are permitted and the relative position of the eye and the head influences neuronal activity in higher visual areas.

In an embodiment, eye lateral and longitudinal position are mapped in the vehicle, in addition to pupil location. The angle and orientation of a user's pupils may be determined by the type of eye tracking sensor 202 utilized in the system. The vehicle controller 102 may receive the eye tracking data and provide an approximate reference direction and location that the user is looking at to determine the user's approximate field of vision. The vehicle controller 102 may determine an object of focus determination based on the pupil angle and orientation at a precise moment. This data may be coupled with localization data received from a global positioning system to provide a focus point on an object recognized by the vehicle controller 102. If a focus point includes a recognizable object, this may indicate an object identification hit which may indicate that the user has visually focused on the object. The object identification hit may be stored in onboard RAM memory in the vehicle controller 102 and/or it may be provided to the network 106 to be stored on a cloud-based storage system.

In an embodiment, collected object identification hits are categorized based on localization and the generic descriptor of an object that was focused on. Such data can be distributed to interested parties, such as advertisers or marketing teams, for a fee. Such data can lead to determining the effectiveness of an advertisement, design, trademark, and so forth. The data may further provide information on user profiles that register the most object identification hits on a particular advertisement.

In an embodiment, a user enters a vehicle and may be notified of an expected zone where the user should direct his eyes to provide data election to the eye tracking sensor 202. The user may be notified when the user's eyes are outside the trackable zone for a time period, such as for 10 seconds, and the eye tracking sensor 202 cannot collect eye tracking data from the user. In an embodiment, one or more deviations outside the trackable zone are recorded and provided to the vehicle controller 102.

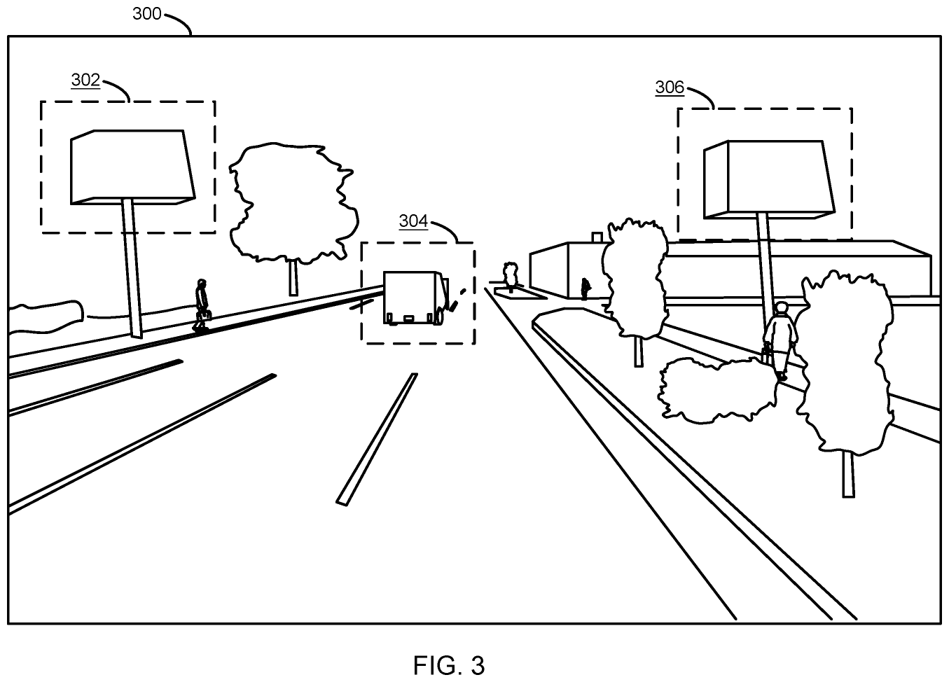

FIG. 3 illustrates an example field of vision 300 of a user of a vehicle. In an embodiment, the field of vision 300 may be determined with data received from the eye tracking sensor 104. In an embodiment, the field of vision 300 may be exterior to the vehicle and the user may be interior to the vehicle. In an embodiment as illustrated, the system 100 may be interested in advertisements or advertisement-like objects located within the field of vision 300. In such an embodiment, the system 100 may capture and receive images by external vehicle sensors of the field of vision 300, and the neural network 114 may be configured to determine advertisement objects within the field of vision. In the field of vision 300 illustrated in FIG. 3, there exists three advertisements or advertisement-like objects 302, 304, and 306. In such an embodiment, the system 100 may be configured to determine a generic descriptor of the objects, such as for example “billboard” at 302 and 306, or “vehicle advertisement” at 304. The system 100 may further be configured to determine an individual descriptor of each object, including for example a trademark or trade name visible on the object, a QR code visible on the object, an image of the object, a description of the advertisement, words visible on the object, and so forth.

FIG. 4 illustrates a schematic block diagram of an object identification component 402. In an embodiment, the object identification component 402 comprises a processing component of, for example, the server 110, the neural network 114, and/or the vehicle controller 102. The object identification component 402 may be configured to provide object identification data about an object within a field of vision of the user. Such object identification data may include, for example, location 404, generic descriptor 406, time period 408, date and time 410, image 412 of the object, individual descriptor 414, distance from vehicle 416 or user, and a positive gaze lock 418.

The location 404 data may include either of a location of the vehicle/user when the object was within the user's field of vision, or a location of the object. Such location 404 data may be determined based on data received from a global positioning system. In an embodiment, the vehicle controller 102 receives data from a global positioning system and that data may be used to determine the location 404. Additionally, map data stored in the database 108 may provide additional insight into the location of the object and/or the vehicle at the time the object was within the user's field of vision.

The generic descriptor 406 may include a general description of the object such as a general identity of the object. Examples of generic descriptors 406 include, for example, billboard, building, pedestrian, tree, vehicle, vehicle advertisement, mobile phone advertisement, mobile phone application, mobile phone, interior of the vehicle, and so forth. In an embodiment, the system 100 may be configured to save data concerning certain objects relevant to the system's 100 objectives. In an embodiment, the system 100 may be configured to determine advertisements the user viewed during a drive or ride sharing trip. In such an embodiment, the vehicle controller 102 may store object data for billboards, vehicle advertisements, and so forth.

The time period 408 and the date and time 410 include time data for when the object was within the user's field of vision. The time period 408 may include a length of time that the object was within the user's field of vision or that the user had a positive gaze lock 418 on the object. The date and time 410 may include a date the object was within the user's field of vision and/or a time of day the object was within the user's field of vision. In an embodiment, data stored on the database 108 may aid in determining an identity of the object based on the date and time 410 the object was viewed.

The image 412 may include a photograph or video stream of the object. In an embodiment, external vehicle sensors, such as external vehicle cameras, radar, and/or LIDAR may provide an image or other data (such as heat vision data, radar data, and so forth) of the object within the user's field of vision. In an embodiment, the image 412 data may be utilized by the neural network 114 to determine a generic descriptor 406 and/or an individual descriptor 414 of the object.

The individual descriptor 414 may include a specific description of the object within the user's field of vision. Examples of specific descriptions include, for example, a trademark affixed to the object, a trade name affixed to the object, a color and/or color scheme of the object, a word or words visible on the object, a description of an image visible on the object, a QR code visible on the object, a description of a particular advertisement scheme visible on the object, and so forth. In an embodiment, the individual descriptor 414 may be determined by the neural network 114 and returned to the vehicle controller 102 via the server 110.

The distance from vehicle 416 may include a distance the object may be located from either of the vehicle and/or the user. Such data may be combined with global positioning data to aid in determining an identification of the object. Such data may be determined by various vehicle sensors, including cameras, LIDAR, radar, and so forth.

The positive gaze lock 418 may be an indication that the user has affirmatively viewed the object within the user's field of vision. The positive gaze lock 418 may be determined by the eye tracking sensor 104. In an embodiment, the positive gaze lock 418 may be determined by a positive affirmation by the user that the user has viewed a specific object. Such an embodiment may be utilized when the user is wearing, for example, augmented reality glasses or goggles that enable the user to identify particular objects within the user's field of vision.

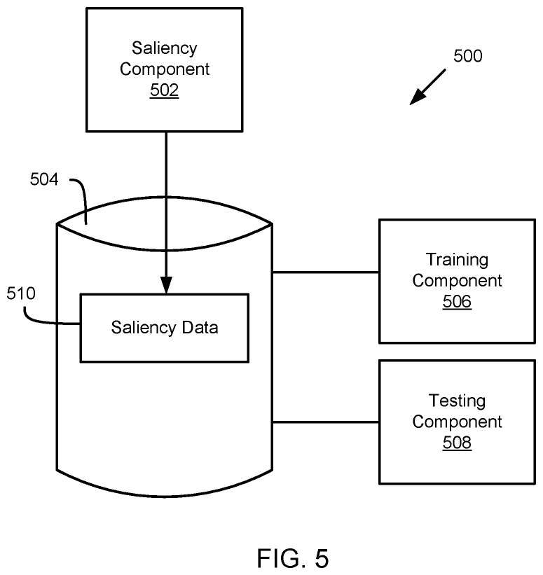

FIG. 5 is a schematic block diagram illustrating example components of a saliency component. FIG. 5 illustrates one embodiment of a system 500 for determining an identity of an object within a user's field of vision. The system 500 may include a saliency component 502, storage 504, a training component 506, and a testing component 508. The saliency component 502 may be configured to determine saliency information based on a data image and ground truth data. The data image may include a frame of sensor data and the ground truth may include information about the frame sensor data. For example, the ground truth may include one or more bounding boxes, a classification, an orientation, and/or a relative location for objects of interest within the sensor data or the user's field of vision. The bounding boxes may include indications of one or more sub-regions within the data image corresponding to one or more objects of interest. The classification may include an indication of a type or classification of a detected object. For example, the classification may indicate that a detected object is a billboard, a building, a vehicle advertisement, a vehicle, a pedestrian, a cyclist, a motorcycle, road debris, a road sign, a lane barrier, a tree or plant, a building, a parking barrier, a side walk, or any other object or feature on or near a roadway. The orientation may indicate an orientation of an object or a direction of travel of an object, such as an orientation or direction of travel of a vehicle, a pedestrian, or any other object. The relative location may indicate a distance between a vehicle and the object.

The saliency component 502 may determine saliency information by automatically generating an artificial label or artificial saliency map based on the data image and/or the ground truth. According to one embodiment, the saliency component 502 may generate multiple random points (which are set to be white pixels) within an indicated bounding box, set all other pixels black, perform a Gaussian blur to the image to produce a label, store a low resolution version of the label, and generate a saliency map based on the data and label information to predict the location of objects in the image. The saliency component 502 may output and/or store saliency data 510 to storage 504. For example, the saliency data may store a label image or a saliency map as part of the saliency data 510.

The training component 506 may be configured to train a machine learning algorithm using the data image and any corresponding ground truth or saliency data 510. For example, the training component 506 may train a machine learning algorithm or model by providing a frame of sensor data with a corresponding label image or saliency map to train the machine learning algorithm or model to output a saliency map or predict locations of objects of interest in any image. For example, the machine learning algorithm or model may include a deep neural network that may be used to identify one or more regions of an image that include an object of interest, such as a billboard, a vehicle advertisement, a pedestrian, vehicle, or other objects to be detected or localized by a vehicle controller 102 or system 100. In one embodiment, the deep neural network may output the indications of regions in the form of a saliency map or any other format that indicates fixation or saliency sub-regions of an image.

The testing component 508 may test a machine learning algorithm or model using the saliency data 510. For example, the testing component 508 may provide an image or other sensor data frame to the machine learning algorithm or model, which then outputs a saliency map or other indications of fixation or saliency. As another example, the testing component 508 may provide an image or other sensor data frame to the machine learning algorithm or model, which determines a classification, location, orientation, or other data about an object of interest. The testing component 508 may compare the output of the machine learning algorithm or model with an artificial saliency or ground truth to determine how well a model or algorithm performs. For example, if the saliency maps or other details determined by the machine learning algorithm or model are the same or similar, the testing component 508 may determine that machine learning algorithm or model is accurate or trained well enough for operation in a real-world system.

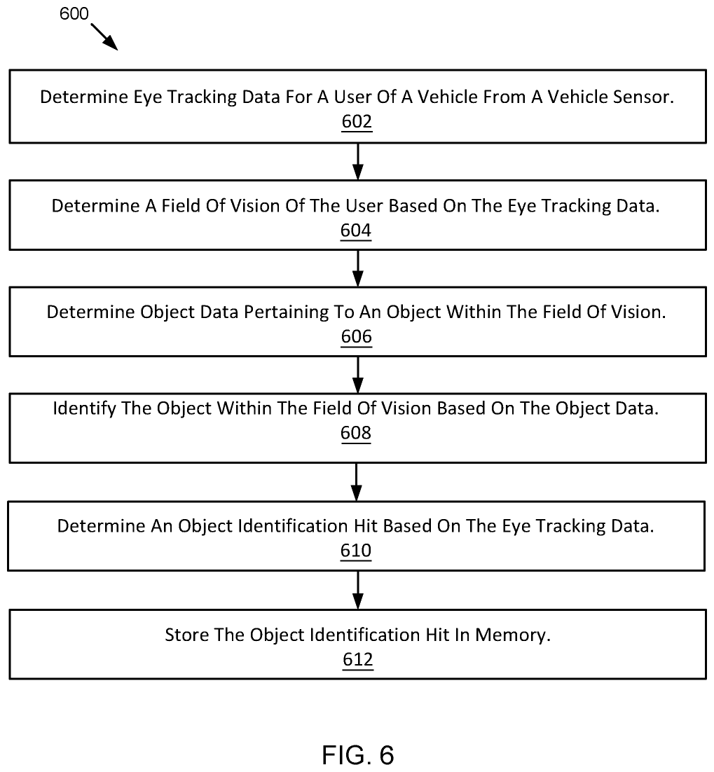

FIG. 6 illustrates a schematic flow chart diagram of a method 600 of identifying an object within a user's field of vision. The method 600 begins and a vehicle controller determines eye tracking data associated with a user of a vehicle from a vehicle sensor at 602. The vehicle controller determines a field of vision of the user based on the eye tracking data at 604. The vehicle controller determines object data associated with an object within the field of vision at 606. The vehicle controller identifies the object within the field of vision based on the object data at 608. It should be appreciated that the vehicle controller at 608 may identify the object by providing the object data to, for example, a neural network for making further determinations about an identity of the object. The vehicle controller determines an object identification hit based on the eye tracking data at 610. The vehicle controller stores the object identification hit in memory at 612.

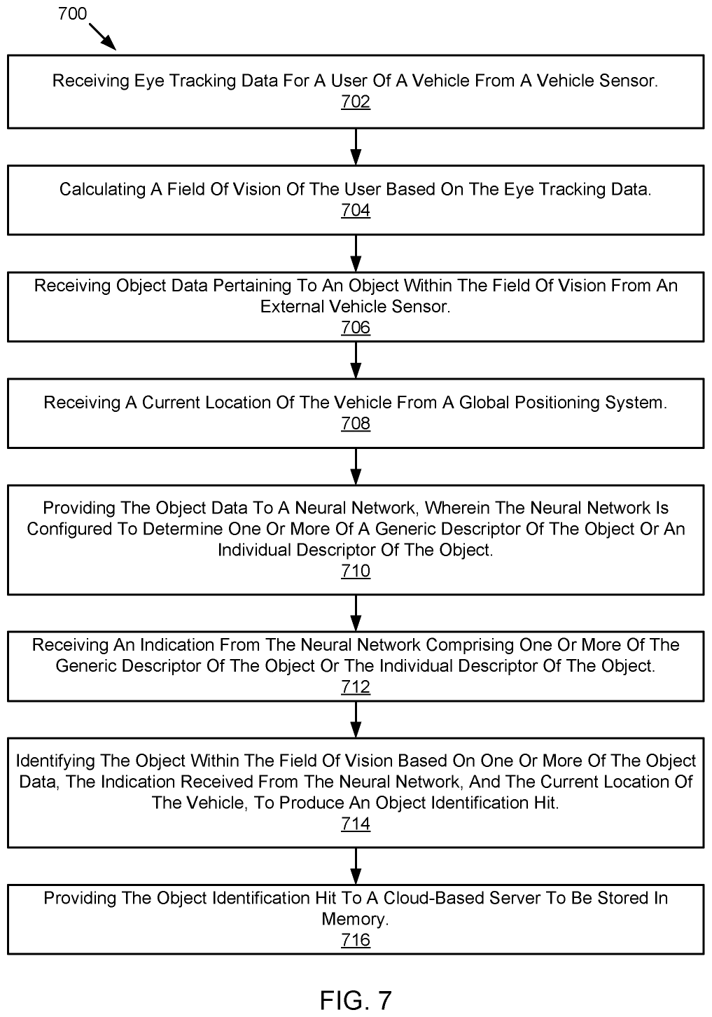

FIG. 7 illustrates a schematic flow chart diagram of a method 700 of identifying an object within a user's field of vision. The method 700 begins and a vehicle controller receives eye tracking data for a user of a vehicle from a vehicle sensor at 702. The vehicle controller calculates and determines a field of vision of the user based on the eye tracking data at 704. The vehicle controller receives object data pertaining to an object within the field of vision from an external vehicle sensor at 706. The vehicle controller receives a current location of the vehicle from a global positioning system at 708. The vehicle controller provides the object data to a neural network, wherein the neural network may be configured to determine one or more of a generic descriptor of the object or an individual descriptor of the object at 710. The vehicle controller receives an indication from the neural network comprising one or more of the generic descriptor of the object or the individual descriptor of the object at 712. The vehicle controller identifies the object within the field of vision based on one or more of the object data, the indication received from the neural network, and the current location of the vehicle, to produce an object identification hit at 714. The vehicle controller provides the object identification hit to a cloud-based server to be stored in memory at 716.

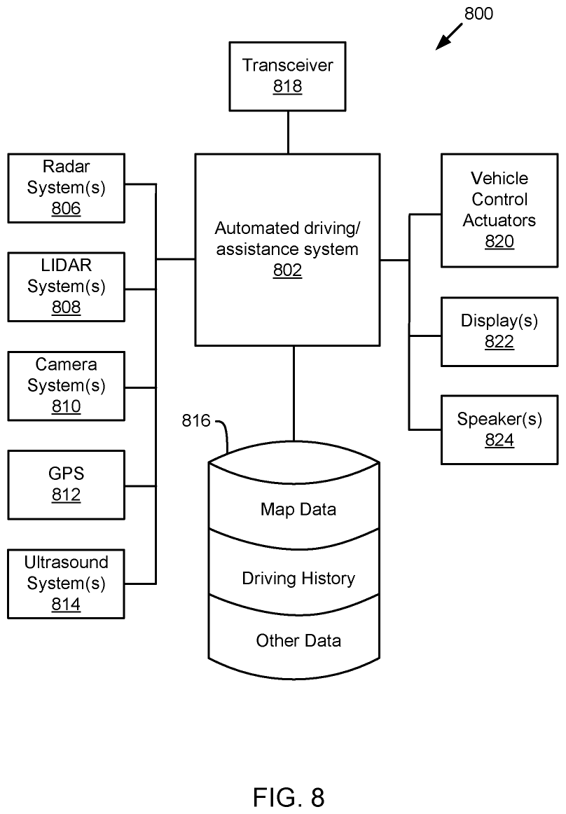

FIG. 8 illustrates an example vehicle control system 100 that may be used for autonomous or assisted driving. The automated driving/assistance system 802 may be used to automate or control operation of a vehicle or to aid a human driver. For example, the automated driving/assistance system 802 may control one or more of braking, steering, acceleration, lights, alerts, driver notifications, radio, or any other auxiliary systems of the vehicle. In another example, the automated driving/assistance system 802 may not be able to provide any control of the driving (e.g., steering, acceleration, or braking), but may provide notifications and alerts to assist a human driver in driving safely. The automated driving/assistance system 802 may use a neural network, or other model or algorithm to detect or localize objects based on perception data gathered by one or more sensors.

The vehicle control system 800 also may include one or more sensor systems/devices for detecting a presence of objects near or within a sensor range of a parent vehicle (e.g., a vehicle that includes the vehicle control system 800). For example, the vehicle control system 800 may include one or more radar systems 806, one or more LIDAR systems 808, one or more camera systems 810, a global positioning system (GPS) 812, and/or one or more ultrasound systems 814. The vehicle control system 800 may include a data store 816 for storing relevant or useful data for navigation and safety such as map data, driving history or other data. The vehicle control system 800 may also include a transceiver 818 for wireless communication with a mobile or wireless network, other vehicles, infrastructure, or any other communication system.

The vehicle control system 800 may include vehicle control actuators 820 to control various aspects of the driving of the vehicle such as electric motors, switches or other actuators, to control braking, acceleration, steering or the like. The vehicle control system 800 may also include one or more displays 822, speakers 824, or other devices so that notifications to a human driver or passenger may be provided. A display 822 may include a heads-up display, dashboard display or indicator, a display screen, or any other visual indicator which may be seen by a driver or passenger of a vehicle. A heads-up display may be used to provide notifications or indicate locations of detected objects or overlay instructions or driving maneuvers for assisting a driver. The speakers 824 may include one or more speakers of a sound system of a vehicle or may include a speaker dedicated to driver notification.

It will be appreciated that the embodiment of FIG. 8 is given by way of example only. Other embodiments may include fewer or additional components without departing from the scope of the disclosure. Additionally, illustrated components may be combined or included within other components without limitation.

In one embodiment, the automated driving/assistance system 802 may be configured to control driving or navigation of a parent vehicle. For example, the automated driving/assistance system 802 may control the vehicle control actuators 820 to drive a path on a road, parking lot, driveway or other location. For example, the automated driving/assistance system 802 may determine a path based on information or perception data provided by any of the components 806-818. The sensor systems/devices 806-810 and 814 may be used to obtain real-time sensor data so that the automated driving/assistance system 802 can assist a driver or drive a vehicle in real-time.

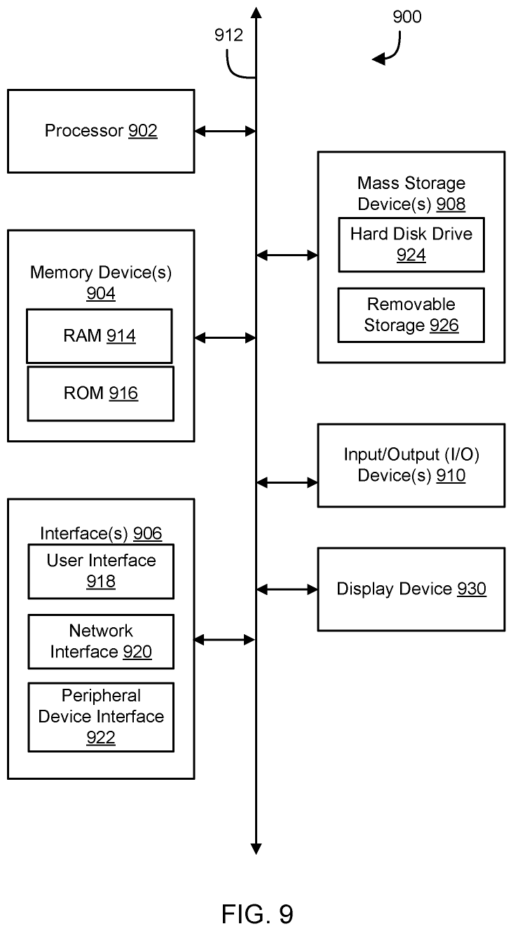

Referring now to FIG. 9, a block diagram of an example computing device 900 is illustrated. Computing device 900 may be used to perform various procedures, such as those discussed herein. In one embodiment, the computing device 900 can function as a neural network 114, vehicle controller 102, a server 110, and the like. Computing device 900 can perform various monitoring functions as discussed herein, and can execute one or more application programs, such as the application programs or functionality described herein. Computing device 900 can be any of a wide variety of computing devices, such as a desktop computer, in-dash computer, vehicle control system, a notebook computer, a server computer, a handheld computer, tablet computer and the like.

Computing device 900 may include one or more processor(s) 902, one or more memory device(s) 904, one or more interface(s) 906, one or more mass storage device(s) 908, one or more input/output (I/O) device(s) 910, and a display device 930 any of which may be coupled to a bus 912. Processor(s) 902 include one or more processors or controllers that execute instructions stored in memory device(s) 904 and/or mass storage device(s) 908. Processor(s) 902 may also include various types of computer-readable media, such as cache memory.

Memory device(s) 904 include various computer-readable media, such as volatile memory (e.g., random access memory (RAM) 914) and/or nonvolatile memory (e.g., read-only memory (ROM) 916). Memory device(s) 904 may also include rewritable ROM, such as Flash memory.

Mass storage device(s) 908 include various computer readable media, such as magnetic tapes, magnetic disks, optical disks, solid-state memory (e.g., Flash memory), and so forth. As shown in FIG. 9, a particular mass storage device may be a hard disk drive 924. Various drives may also be included in mass storage device(s) 908 to enable reading from and/or writing to the various computer readable media. Mass storage device(s) 908 include removable media 926 and/or non-removable media.

I/O device(s) 910 include various devices that allow data and/or other information to be input to or retrieved from computing device 900. Example I/O device(s) 910 include cursor control devices, keyboards, keypads, microphones, monitors or other display devices, speakers, printers, network interface cards, modems, and the like.

Display device 930 may include any type of device capable of displaying information to one or more users of computing device 900. Examples of display device 930 include a monitor, display terminal, video projection device, and the like.

Interface(s) 906 include various interfaces that allow computing device 900 to interact with other systems, devices, or computing environments. Example interface(s) 906 may include any number of different network interfaces 920, such as interfaces to local area networks (LANs), wide area networks (WANs), wireless networks, and the Internet. Other interface(s) include user interface 918 and peripheral device interface 922. The interface(s) 906 may also include one or more user interface elements 918. The interface(s) 906 may also include one or more peripheral interfaces such as interfaces for printers, pointing devices (mice, track pad, or any suitable user interface now known to those of ordinary skill in the field, or later discovered), keyboards, and the like.

Bus 912 allows processor(s) 902, memory device(s) 904, interface(s) 906, mass storage device(s) 908, and I/O device(s) 910 to communicate with one another, as well as other devices or components coupled to bus 912. Bus 912 represents one or more of several types of bus structures, such as a system bus, PCI bus, IEEE bus, USB bus, and so forth.

For purposes of illustration, programs and other executable program components are shown herein as discrete blocks, although it is understood that such programs and components may reside at various times in different storage components of computing device 900 and are executed by processor(s) 902. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

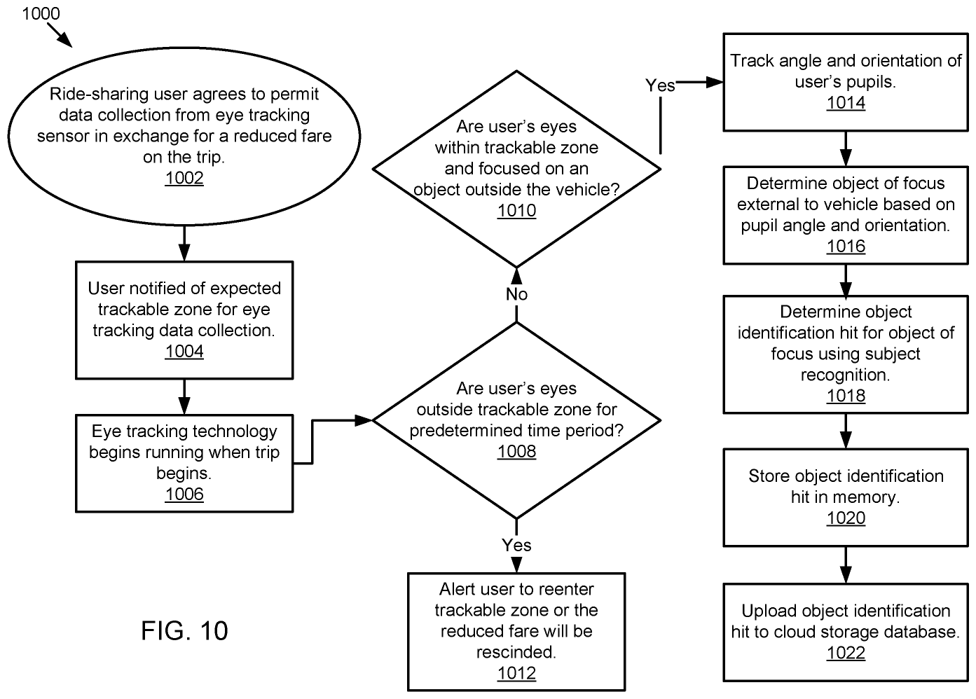

FIG. 10 illustrates a schematic flow chart diagram of a process flow 1000 for determining an object identification hit based on a user's field of vision during a ride sharing trip. The process flow 1000 begins and a ride sharing user agrees to permit data collection from an eye tracking sensor in exchange for a reduced fare on the ride sharing trip at 1002. The user may be notified of an expected trackable zone for the eye tracking sensor data collection at 1004. The eye tracking technology begins running when the trip begins at 1006. A determination may be made at 1008 determining whether the user's eyes are outside the trackable zone for a predetermined time period. If the user's eyes are outside the trackable zone for a time period, an alert may be provided to the user to reenter the trackable zone or the user's reduced fare for the ride sharing trip will be rescinded at 1012. If the user's eyes are not outside a trackable zone for a time period, then a determination may be made at 1010 whether the user's eyes are within the trackable zone of the eye tracking sensor and the user's eyes are focused on an object outside the vehicle. If the user's eyes are focused on an object outside the vehicle, then the angle and orientation of the user's pupils are tracked at 1014. The process flow 1000 may include determining an object of focus external to the vehicle based on the user's pupil angle and orientation at 1016. The process flow 1000 may include determining an object identification hit awarded to the object of focus using a subject recognition algorithm or other process at 1018. The process flow 1000 may include storing the object identification hit in memory at 1020. The process flow 1000 may include uploading the object identification hit to a cloud storage database at 1022.

### EXAMPLES

In some instances, the following examples may be implemented together or separately by the systems and methods described herein.

Example 1 may include a method comprising: determining eye tracking data associated with a user of a vehicle from a vehicle sensor; determining a field of vision of the user based on the eye tracking data; determining object data associated with an object within the field of vision; identifying the object within the field of vision based on the object data; determining an object identification hit based on the eye tracking data; and storing the object identification hit in memory accessible to the vehicle.

Example 2 may include the method of example 1 and/or some other example herein, wherein determining the field of vision of the user comprises determining a gaze based on the eye tracking data, wherein the eye tracking data includes an angle and orientation of an eye.

Example 3 may include the method of example 1 and/or some other example herein, further comprising receiving a location of the vehicle from a global positioning system.

Example 4 may include the method of example 3 and/or some other example herein, further comprising determining a location of the object within the field of vision based on one or more of the location of the vehicle and the object data.

Example 5 may include the method of example 1 and/or some other example herein, further comprising determining an indication that the user of the vehicle agrees to permit collection of the eye tracking data.

Example 6 may include the method of example 1 and/or some other example herein, further comprising determining that an eye of the user of the vehicle is outside a trackable zone for the vehicle sensor.

Example 7 may include the method of example 6 and/or some other example herein, further comprising providing a notification that the vehicle sensor cannot collect the eye tracking data.

Example 8 may include the method of example 1 and/or some other example herein, wherein the object within the field of vision is located at an exterior of the vehicle and wherein the object data is received from an exterior vehicle sensor.

Example 9 may include the method of example 1 and/or some other example herein, wherein the object identification hit comprises one or more of: a location of the object; a generic descriptor of the object; a length of time the object was within the field of vision of the user; a date that the object was within the field of vision of the user; a time of day that the object was within the field of vision of the user; an image of the object; an individual descriptor of the object comprising an indication of a text or image visible on the object; and a distance between the object and the vehicle.

Example 10 may include the method of example 1 and/or some other example herein, wherein identifying the object within the field of vision comprises: providing the object data to a neural network, wherein the neural network is configured to determine one or more of a generic descriptor of the object or an individual descriptor of the object; and determining an indication received from the neural network comprising one or more of the generic descriptor of the object or the individual descriptor of the object.

Example 11 may include the method of example 1 and/or some other example herein, wherein storing the object identification hit in memory comprises providing the object identification hit to a cloud storage sever.

Example 12 may include a non-transitory computer-readable storage media storing instructions that, when executed by one or more processors, cause the one or more processors to: determine eye tracking data associated with a user of a vehicle from a vehicle sensor; determine a field of vision of the user of the vehicle based on the eye tracking data; determine object data associated with an object within the field of vision; identify the object within the field of vision based on the object data; determine an object identification hit based on the eye tracking data; and store the object identification hit in memory.

Example 13 may include the non-transitory computer-readable storage media of example 12 and/or some other example herein, wherein the instructions further cause the one or more processors to determine a location of the object within the field of vision based on one or more of a location of the vehicle and the object data.

Example 14 may include the non-transitory computer-readable storage media of example 12 and/or some other example herein, wherein the instructions further cause the one or more processors to determine that an eye of the user is outside a trackable zone for the vehicle sensor.

Example 15 may include the non-transitory computer-readable storage media of example 12 and/or some other example herein, wherein the object identification hit comprises one or more of: a location of the object; a generic descriptor of the object; a length of time the object was within the field of vision of the user; a date that the object was within the field of vision of the user; a time of day that the object was within the field of vision of the user; an image of the object; an individual descriptor of the object comprising an indication of a text or image visible on the object; and a distance between the object and the vehicle.

Example 16 may include the non-transitory computer-readable storage media of example 12 and/or some other example herein, wherein causing the one or more processors to identify the object within the field of vision further comprises causing the one or more processors to: provide the object data to a neural network, wherein the neural network is configured to determine one or more of a generic descriptor of the object or an individual descriptor of the object; and determine an indication received from the neural network comprising one or more of the generic descriptor of the object or the individual descriptor of the object.

Example 17 may include a system comprising: a vehicle sensor; a vehicle controller in electronic communication with the vehicle sensor, wherein the vehicle controller comprises computer-readable storage media storing instructions that, when executed by one or more processors, cause the one or more processors to: determine eye tracking data associated with a user of a vehicle from the vehicle sensor; determine a field of vision of the user of the vehicle based on the eye tracking data; determine object data associated with an object within the field of vision; identify the object within the field of vision based on the object data; determine an object identification hit based on the eye tracking data; and store the object identification hit in memory accessible to the vehicle.

Example 18 may include the system of example 17 and/or some other example herein, further comprising a neural network in communication with the vehicle controller, wherein the neural network is configured to determine one or more of a generic descriptor of the object or an individual descriptor of the object.

Example 19 may include the system of example 18 and/or some other example herein, wherein the computer-readable storage media causes the one or more processors to identify the object within the field of vision by further causing the one or more processors to: provide the object data to the neural network; and determine an indication received from the neural network comprising one or more of the generic descriptor of the object or the individual descript of the object.

Example 20 may include the system of example 17 and/or some other example herein, further comprising an exterior vehicle sensor located on an exterior of the vehicle, wherein the exterior vehicle sensor provides the object data associated with the object within the field of vision.

In the above disclosure, reference has been made to the accompanying drawings, which form an object hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium, which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general-purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. The terms “modules” and “components” are used in the names of certain components to reflect their implementation independence in software, hardware, circuitry, sensors, or the like. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of objects so described and illustrated. The scope of the disclosure is to be defined by the claims appended hereto, any future claims submitted here and in different applications, and their equivalents.

What is claimed is:

1. A method comprising:
determining eye tracking data associated with a user of a vehicle from a vehicle sensor;
determining a field of vision of the user based on the eye tracking data;
determining object data associated with an object within the field of vision;
identifying the object within the field of vision based on the object data;
determining an object identification hit based on the eye tracking data; and
storing the object identification hit in memory accessible to the vehicle.

2. The method of claim 1, wherein determining the field of vision of the user comprises determining a gaze based on the eye tracking data, wherein the eye tracking data includes an angle and orientation of an eye.

3. The method of claim 1, further comprising receiving a location of the vehicle from a global positioning system.

4. The method of claim 3, further comprising determining a location of the object within the field of vision based on one or more of the location of the vehicle and the object data.

5. The method of claim 1, further comprising determining an indication that the user of the vehicle agrees to permit collection of the eye tracking data.

6. The method of claim 1, further comprising determining that an eye of the user of the vehicle is outside a trackable zone for the vehicle sensor.

7. The method of claim 6, further comprising providing a notification that the vehicle sensor cannot collect the eye tracking data.

8. The method of claim 1, wherein the object within the field of vision is located at an exterior of the vehicle and wherein the object data is received from an exterior vehicle sensor.

9. The method of claim 1, wherein the object identification hit comprises one or more of:
a location of the object;
a generic descriptor of the object;
a length of time the object was within the field of vision of the user;
a date that the object was within the field of vision of the user;
a time of day that the object was within the field of vision of the user;
an image of the object;
an individual descriptor of the object comprising an indication of a text or image visible on the object; or
a distance between the object and the vehicle.

10. The method of claim 1, wherein identifying the object within the field of vision comprises:
providing the object data to a neural network, wherein the neural network is configured to determine one or more of a generic descriptor of the object or an individual descriptor of the object; and
determining an indication received from the neural network comprising one or more of the generic descriptor of the object or the individual descriptor of the object.

11. The method of claim 1, wherein storing the object identification hit in memory comprises providing the object identification hit to a cloud storage sever.

12. Non-transitory computer-readable storage media storing instructions that, when executed by one or more processors, cause the one or more processors to:
determine eye tracking data associated with a user of a vehicle from a vehicle sensor;
determine a field of vision of the user of the vehicle based on the eye tracking data;
determine object data associated with an object within the field of vision;
identify the object within the field of vision based on the object data;
determine an object identification hit based on the eye tracking data; and
store the object identification hit in memory.

13. The non-transitory computer-readable storage media of claim 12, wherein the instructions further cause the one or more processors to determine a location of the object within the field of vision based on one or more of a location of the vehicle and the object data.

14. The non-transitory computer-readable storage media of claim 12, wherein the instructions further cause the one or more processors to determine that an eye of the user is outside a trackable zone for the vehicle sensor.

15. The non-transitory computer-readable storage media of claim 12, wherein the object identification hit comprises one or more of:
a location of the object;
a generic descriptor of the object;
a length of time the object was within the field of vision of the user;
a date that the object was within the field of vision of the user;
a time of day that the object was within the field of vision of the user;
an image of the object;
an individual descriptor of the object comprising an indication of a text or image visible on the object; and
a distance between the object and the vehicle.

16. The non-transitory computer-readable storage media of claim 12, wherein causing the one or more processors to identify the object within the field of vision further comprises causing the one or more processors to:
provide the object data to a neural network, wherein the neural network is configured to determine one or more of a generic descriptor of the object or an individual descriptor of the object; and
determine an indication received from the neural network comprising one or more of the generic descriptor of the object or the individual descriptor of the object.

17. A system comprising:
a vehicle sensor;
a vehicle controller in electronic communication with the vehicle sensor, wherein the vehicle controller comprises computer-readable storage media storing instructions that, when executed by one or more processors, cause the one or more processors to:
determine eye tracking data associated with a user of a vehicle from the vehicle sensor;
determine a field of vision of the user of the vehicle based on the eye tracking data;
determine object data associated with an object within the field of vision;
identify the object within the field of vision based on the object data;
determine an object identification hit based on the eye tracking data; and
store the object identification hit in memory accessible to the vehicle.

18. The system of claim 17, further comprising a neural network in communication with the vehicle controller, wherein the neural network is configured to determine one or more of a generic descriptor of the object or an individual descriptor of the object.

19. The system of claim 18, wherein the computer-readable storage media causes the one or more processors to identify the object within the field of vision by further causing the one or more processors to:
provide the object data to the neural network; and
determine an indication received from the neural network comprising one or more of the generic descriptor of the object or the individual description of the object.

20. The system of claim 17, further comprising an exterior vehicle sensor located on an exterior of the vehicle, wherein the exterior vehicle sensor provides the object data associated with the object within the field of vision.
